(19) United States
(12) Patent Application Publication
(10) Pub. No.: US 2014/0155337 A1
(43) Pub. Date: Jun. 5, 2014

(54) Molluscicidal Agents and Uses Thereof

(71) Applicant: Stephen Reynold Ford, Auckland (NZ)

(72) Inventor: Stephen Reynold Ford, Auckland (NZ)

(73) Assignee: BIOTELLIGA HOLDINGS LIMITED, Auckland (NZ)

(21) Appl. No.: 14/115,751

(22) PCT Filed: May 4, 2012
(86) PCT No.: PCT/IB2012/052234

§ 371 Date: Feb. 11, 2014

Related U.S. Application Data
(60) Provisional application No. 61/482,780, filed on May 5, 2011.

(51) Int. Cl. A01N 45/00

(52) U.S. Cl. CPC A01N 45/00
USPC 514/26

(57) ABSTRACT

The present invention provides molluscicidal saponins and saponin fractions from Camellia sinensis, together with compositions comprising such saponins and saponin fractions, and methods of preparing same. Methods for the control of molluscs, including terrestrial molluscs, such as slugs or snails, using the saponins and saponin fractions or compositions comprising said saponins or saponin fractions optionally together with one or more pesticidal agents including molluscicidal agents, are also provided.

### FIELD OF THE INVENTION

This invention relates generally to the field of biology, more particularly certain embodiments concern saponins prepared from Camellia sinensis, compositions comprising said saponins, and the use of such saponins and compositions as biological control agents. Methods for the control of molluscs, including terrestrial molluscs, using the saponins and compositions comprising the saponins are also provided.

### BACKGROUND OF THE INVENTION

Plant loss caused by pests and pathogens, such as for example molluscs, including terrestrial molluscs such as slugs and snails (collectively, “molluscs”), is a significant economic cost to plant-based agriculture and industries and to domestic gardening. Losses may arise through spoilage of produce both pre and post harvest, loss of plants themselves, or through reduction in growth and production abilities.

Traditionally, large scale control of plant pests and pathogens has been pursued through the application of chemical insecticides, though physical methods (e.g., trapping, picking, barriers) may also be employed. The use of chemicals is subject to a number of disadvantages. Plant pests and pathogens can and have developed tolerance to chemicals to over time, producing resistant populations. For example, snails have developed resistance to some pesticides, such as the synthetic chemicals metaldehyde and methiocarb. Indeed, resistance to pesticides is the greatest challenge to the viability of plant-based agriculture and industries such as the horticultural industry.

Chemical residues may also pose environmental hazards, and raise health concerns. The revival of interest in biological control such as microbial insecticides over the last 20 years has come directly from public pressure in response to concerns about chemical toxicities. Biological control presents an alternative means of controlling plant pathogens which is potentially more effective and specific than current methods, as well as reducing dependence on chemicals. Such biological control methods are perceived as a “natural” alternative to chemical insecticides with the advantage of greater public acceptance, reduced environmental contamination, and increased sustainability.

Mechanisms of biological control are diverse. One mechanism which has been demonstrated to be effective is the use of antagonistic microorganisms such as bacteria to control insects. For example, the large scale production of Bacillus thuringiensis enabled the use of this bacterio-insecticide to control painted apple moth in Auckland, New Zealand.

There is little information on the successful application of molluscicidal saponins, and the industrial production of such saponins is still relatively unsophisticated.

There is thus a need for agents and methods for effectively controlling molluscs, including terrestrial molluscs such as slugs and snails, particularly agents that act faster, have increased efficacy in controlling molluscs including terrestrial molluscs, require less frequent or less intensive application, have lower cost, or have lower resulting toxicity than the currently-available molluscicides.

It is therefore an object of the present invention to go some way to meeting this need, to provide one or more agents and methods useful in the control of molluscs, including terrestrial molluscs, or at least to provide the public with a useful choice.

### SUMMARY OF THE INVENTION

The present invention provides molluscicidal compositions comprising saponins, and methods for preparing them.

Accordingly, in a first aspect, the invention relates to a molluscicidal composition comprising one or more saponins from Camellia sinensis or one or more saponin fractions from Camellia sinensis.

In one embodiment, the composition is or comprises an aqueous extract from Camellia sinensis wherein the extract is or was prepared by extraction with aqueous solvent at

(a) greater than about 100° C.,

(b) greater than one atmosphere, or

(c) both (a) and (b).

In a second aspect the invention relates to an isolated, purified or substantially pure molluscicidal saponin fraction from Camellia sinensis.

In one embodiment, the fraction is or comprises an aqueous fraction from Camellia sinensis wherein the fraction is or was prepared by extraction with aqueous solvent at

(a) greater than about 100° C.,

(b) greater than one atmosphere, or

(c) both (a) and (b).

The compositions and formulations of the invention may comprise one or more saponins from Camellia sinensis, one or more saponin fractions from Camellia sinensis, or one or more saponins from Camellia sinensis and one or more saponin fractions from Camellia sinensis, together with at least one agriculturally acceptable carrier.

In a further aspect, the invention provides a method of preparing a saponin or saponin fraction having molluscicidal activity against a mollusc, such as for example a terrestrial mollusc such as a snail or slug. The method generally involves isolating one or more of the saponins or saponin fractions described herein from a suitable extract of Camellia sinensis, including an extract derived from Camellia sinensis seeds, leaves, bark, stems, flowers, with seeds being a preferred source.

In still a further aspect, the invention provides a method for producing a composition comprising one or more saponins from Camellia sinensis, the method comprising:

providing Camellia sinensis or a tissue therefrom or an extract thereof, wherein the Camellia sinensis, the tissue, or the extract comprises one or more saponins,

admixing the Camellia sinensis or the tissue therefrom or the extract thereof and water, maintaining the admixture for a first period at

a) at least about 100° C., or

b) at least about 1 atmosphere, or

c) both (a) and (b),

maintaining the admixture for a second period at

d) at about room temperature, or

e) at less than one atmosphere, or

both (d) and (e), and

removing the supernatant, and optionally combining the supernatant with one or more agriculturally-accceptable carriers, thereby to form the composition.

In one embodiment, the first period is a time sufficient to extract one or more saponins from the Camellia sinensis, or the tissue there from or the extract thereof In one example, the first period is at least about an hour.

In one embodiment, the second period is a time sufficient to extract one or more saponins from the Camellia sinensis, or the tissue therefrom or the extract thereof. In one example, the second period is at least about 12 hours, more preferably at least about 24 hours.

In one embodiment, the method comprises

providing Camellia sinensis or a tissue therefrom or an extract thereof, wherein the Camellia sinensis, the tissue, or the extract comprises one or more saponins,

admixing the Camellia sinensis or the tissue therefrom or the extract thereof and water,

maintaining the admixture for a first period at

a) at about 110° C., or

b) at least about 1 atmosphere, or

c) both (a) and (b),

maintaining the admixture for a second period at

d) at about room temperature, or

e) at less than one atmosphere, or

f) both (d) and (e), and

removing the supernatant, and optionally combining the supernatant with one or more agriculturally-accceptable carriers, thereby to form the composition.

The invention further relates to the use of a composition of the invention for the control one or more molluscs, including terrestrial molluscs, such as one or more molluscs, including terrestrial molluscs, as well as a composition of the invention for such use.

In a further aspect, the present invention provides a method of controlling one or more molluscs, including terrestrial molluscs, the method comprising contacting the one or more molluscs, including terrestrial molluscs, with a composition of the invention.

The present invention further relates to a method for controlling one or more molluscs, including terrestrial molluscs, such as one or more molluscs, including terrestrial molluscs, the method comprising applying to a plant or its surroundings a composition of the invention.

A method of controlling a mollusc population is also provided by the invention. The method generally involves contacting the population with an effective amount of a composition comprising a saponin or saponin fraction from Camellia sinensis. Such methods may be used to kill or reduce the numbers of target molluscs, including terrestrial molluscs, in a given area, or may be prophylactically applied to an environmental area to prevent infestation by a mollusc population.

The following embodiments may relate to any of the aspects herein.

In various embodiments, including for example as or in ready-to-use formulations, the molluscicidal composition of the invention comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 25 1.5, or 2% by weight one or more saponins or saponin fractions.

In various embodiments, including for example as or in ready-to-use formulations, the molluscicidal composition of the invention is a ready-to-use formulation comprising at least about 0.01 g.L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or 10 g.L⁻¹ one or more saponins or saponin fractions.

In various embodiments the composition is a composition obtained or obtainable from Camellia sinensis comprising at least about 1, 2, 3, 4, 5, 6, 7, 8, 9, 10, 15, 20, 25, 30, 35, 40, 45, or 50, 55, 60, 65, 70, 75, 80, 85, 90, 95 or 99% by weight of a saponin or a saponin fraction, and useful ranges may be selected between any of these values (for example, about 1 to about 99, about 5 to about 99, about 10 to about 99, about 15 to about 99, about 20 to about 99, about 25 to about 99, about 30 to about 99, about 35 to about 99, about 40 to about 99, about 45 to about 99, about 50 to about 99, about 55 to about 99, about 60 to about 99, about 65 to about 99, about 70 to about 99, about 75 to about 99, about 80 to about 99, about 85 to about 99, or about 90 to about 99% by weight).

It should be understood that any compositions useful herein include compositions obtained or obtainable from one or more Camellia sinensis strains or variants, such as those grown for commercial tea production.

In various embodiments, for example on application, a composition of the invention comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more saponins, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the molluscicidal composition of the invention comprises at least about 1%, 1.5, 2, 2.5, 3, 3.5, 4, 4.5, 5, .5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more saponins or saponin fractions.

In various embodiments, the molluscicidal composition of the invention is a formulation comprising at least about 5 g.L⁻¹, 10, 20, 30, 40, 50, 60, 70, 80, 90, 100, 110, 120, 130, 140, 150, 160, 170, 180, 190, 200, 225, 250, 275, 300, 350, 400, 450, 500, or more than 500 g.L⁻¹ of one or more saponins or saponin fractions.

In various embodiments relating to the preparative methods of the invention, the Camellia sinensis comprises Camellia sinensis seed, including powdered Camellia sinensis seed (commonly referred to as “seed cake”).

In various embodiments, the fraction or the extract is or was prepared by extraction at at least about 100° C., at about 105° C., at about 106° C., at about 107° C., at about 108° C., at about 109° C., at about 110° C., at about 115° C., or at about 120° C.

In various embodiments, the fraction or the extract is or was prepared by extraction at about 1.1 bar, at about 1.2 bar, at about 1.3 bar, at about 1.4 bar, at about 1.5 bar, or at about 2 bar. In another example the fraction or the extract is or was prepared by extraction at 2 bar, or at greater than 2 bar. In other examples, the fraction or the extract is or was prepared by extraction at about 1.1 bar to about 1.5 bar, or at about 1.2 bar to about 1.5 bar, or at about 1.2 bar to about 1.4 bar.

In one exemplary embodiment, the fraction or the extract is or was prepared by extraction at about 110° C., for example at about 110° C. and about 1.3 bar.

In one embodiment, the admixing is with sterile water, for example in a sterile pressure vessel optionally pre-sterilized, for example with hydrogen peroxide or other sterilizing agent.

In various embodiments, the admixture is maintained, for example for the first period, at at least about 100° C., at about 105° C., at about 106° C., at about 107° C., at about 108° C., at about 109° C., at about 110° C., at about 115° C., or at about 120° C.

In various embodiments, the admixture is maintained, for example for the first period, at about 1.1 bar, at about 1.2 bar, at about 1.3 bar, at about 1.4 bar, at about 1.5 bar, or at about 2 bar. In another example the admixture is maintained, for example for the first period, at 2 bar, or at greater than 2 bar. In other examples, the admixture is maintained, for example for the first period, at about 1.1 bar to about 1.5 bar, or at about 1.2 bar to about 1.5 bar, or at about 1.2 bar to about 1.4 bar.

In one exemplary embodiment, the admixture is maintained for the first period at about 110° C., for example at about 110° C. and about 1.3 bar.

In various embodiments, the admixture is maintained for the second period at less than about 40° C., at less than about 37.5° C., at less than about 35° C., at less than about 32.5° C., at less than about 30° C., at less than about 29° C., at less than about 28° C., at less than about 27° C., at less than about 26° C., at less than about 25° C., at less than about 24° C., at less than about 23° C., at less than about 22° C., at less than about 21° C., or at less than about 20° C.

In various embodiments, the admixture is maintained for the second period at less than about 1 bar, at less than about 0.9 bar, at less than about 0.8 bar, at less than about 0.7 bar, at less than about 0.6 bar, at less than about 0.5 bar, at less than about 0.4 bar, at less than about 0.3 bar, at less than about 0.2 bar, or less than about 0.1 bar. In one exemplary embodiment, the admixture is maintained for the second period at about 0.5 bar to about 0.2 bar, at about 0.4 bar to about 0.2 bar, or at about 0.35 bar to about 0.25 bar.

In various embodiments, the fraction or the extract is or was prepared by extraction for a time sufficient to extract one or more saponins from the Camellia sinensis, or the tissue there from or the extract thereof. In one example, the extraction is or was for at least about an hour. In other examples, the extraction is or was for at least about 75 minutes, at least about 90 minutes, at least about 105 minutes, at least about 120 minutes, at least about 2.5 hours, or at least about 3 hours.

In various embodiments, the first period is a time sufficient to extract one or more saponins from the Camellia sinensis, or the tissue there from or the extract thereof. In one example, the first period is at least about an hour. In other examples, the first period is at least about 75 minutes, at least about 90 minutes, at least about 105 minutes, at least about 120 minutes, at least about 2.5 hours, or at least about 3 hours.

In various embodiments, the second period is a time sufficient to extract one or more saponins from the Camellia sinensis, or the tissue therefrom or the extract thereof. In one example, the second period is at least about 12 hours. In certain other embodiments, the second period is at least about 15 hours, at least about 18 hours, at least about 21 hours, or at least about 24 hours. In other examples, the second period is at least about 30 hours, at least about 36 hours, at least about 42 hours, or at least about 2 days or more.

In one example, the method comprises

providing Camellia sinensis or a tissue therefrom or an extract thereof, wherein the Camellia sinensis, the tissue, or the extract comprises one or more saponins,

admixing the Camellia sinensis or the tissue therefrom or the extract thereof and water,

maintaining the admixture for about 1 hour at about 110° C. and at about 1.3 Bar,

maintaining the admixture for about 24 hours at about room temperature and at about 0.3 Bar,

removing the supernatant, and optionally combining the supernatant with one or more agriculturally-accceptable carriers, thereby to form the composition.

Various parts of Camellia sinensis, including the seeds, fruit, leaves, roots, bark and trunk are suitable starting materials for the preparative methods of the invention, as are intermediate extracts, such as those obtained by crushing or pressing suitable portions of the plant to yield a saponin-containing liquid. The liquid may subsequently be purified to remove debris. Saponin-containing extracts suitable for use as a starting material may also be obtained though solvent extraction using solvents such as methanol, ethanol, acetone, ethyl acetate, chloroform, hexane, and dichloromethane. Further, seeds, leaves, bark and other portions of saponin-containing Camellia sinensis tissue may be ground and dried to obtain a suitable solid extract.

In various embodiments the supernatant is separated from particulates, for example by centrifugation or by filtration.

In various embodiments, the separation is by filtration, such as cross-flow filtration.

In certain embodiments, the carrier is a stabiliser, such as an organic or food-grade acid including for example acetic acid, sodium benzoate, or the like.

In certain embodiments, the method of preparing a composition having molluscicidal activity comprising one or more saponins or one or more saponin fractions from Camellia sinensis is essentially as herein described.

It will be appreciated that in various embodiments of the preparatory method of the invention, the solvent is an aqueous solvent. Preferably, the solvent is not an organic solvent.

The composition of the invention may be formulated as a powder, dust, pellet, granule, spray, emulsion, colloid, solution, or such like, and may be preparable by such conventional means as desiccation, lyophilization, homogenization, extraction, filtration, centrifugation, sedimentation, or concentration of a culture of cells comprising the saponin. In some embodiments of exemplary compositions that contain at least one such molluscicidal saponin, the saponin is present in a concentration of from about 0.1% to about 99% by weight.

In a further embodiment, the invention provides methods for preparing a molluscicidal saponin composition. In exemplary embodiments, such saponins may be formulated for use as a molluscicidal agent, and may be used to control mollusc populations in an environment, including agricultural environs and the like. In some embodiments, the formulations can be used to kill a mollusc or mollusc population, typically by topical application. In other embodiments, the formulations can be used to antagonise a mollusc or mollusc population, again typically by topical application. In certain instances, it may be desirable to formulate the compositions of the present invention for application to the soil, on or near plants, trees, shrubs, and the like, near live plants, livestock, domiciles, farm equipment, buildings, and the like.

In various embodiments, said biological control composition comprises at least one agriculturally acceptable carrier.

In various embodiments, said at least one carrier is an agriculturally acceptable carriers, more preferably is selected from the group consisting of a filler stimulant, an anti-caking agent, a wetting agent, an emulsifier, and an antioxidant, more preferably said composition comprises at least one of each of a filler stimulant, an anti-caking agent, a wetting agent, an emulsifier, and an antioxidant.

In various embodiments, said filler stimulant is a carbohydrate source, such as a disaccharide including, for example, sucrose, fructose, glucose, or dextrose, said anti-caking agent is selected from talc, silicon dioxide, calcium silicate, or kaelin clay, said wetting agent is skimmed milk powder, said emulsifier is a soy-based emulsifier such as lecithin or a vegetable-based emulsifier such as monodiglyceride, and said antioxidant is sodium glutamate or citric acid.

In various embodiments, the composition is a stable composition capable of retaining molluscicidal efficacy for a period greater than about two weeks, preferably greater than about one month, about two months, about three months, about four months, about five months, more preferably greater than about six months.

In exemplary embodiments, the composition is bacteriostatic. In one example, the composition is bacteriocidal.

Preferably, the carrier is an agriculturally acceptable carrier, preferably the at least one carrier is selected from the group consisting of a filler stimulant, an anti-caking agent, a wetting agent, an emulsifier, and an antioxidant, more preferably said composition comprises at least one of each of a filler stimulant, an anti-caking agent, a wetting agent, an emulsifier, and an antioxidant.

In one embodiment, the compositions of the invention are applied directly to a plant or its surroundings. For example, a composition of the invention is diluted (for example with water) or admixed with a solvent and applied as described herein.

In one embodiment, the present invention provides a method for controlling one or more molluscs, including terrestrial molluscs, the method comprising applying to a plant or its surroundings a composition of the present invention.

In various embodiments, the composition of the invention is applied prophylactically, for example before a plant is infected by or exposed to the mollusc or mollusc population. In other embodiments, the composition is applied when infection is establish or the mollusc or mollusc population is present, for example when a plant is infected by or exposed to the mollusc or mollusc population, or when a mollusc or mollusc population is present on or in the plant or its surroundings.

Preferably, the composition is admixed with water to a final concentration of saponin of about 0.5 gm/L to about 10 gm/L prior to application, and more preferably to a final concentration of about 1 gm/L.

Preferably, the composition is admixed with water prior to application. In one embodiment, the composition is admixed with water and applied in at least about 100 L water/Ha, in at least about 150 L/Ha, in at least about 200 L/Ha, in at least about 250 L/Ha, in at least about 300 L/Ha, in at least about 350 L/Ha, in at least about 400 L/Ha, in at least about 450 L/Ha, or in at least about 500 L/Ha.

Preferably, said application is by spraying.

Conveniently, such a rate of application can be achieved by formulating said composition at about 1 gram saponin, saponin fraction, or saponin-containing composition per litre. As discussed herein, such an application rate can be conveniently achieved by dissolution of the composition in a larger volume of agriculturally acceptable solvent, for example, water.

The invention is applicable to any plant or its surroundings. Exemplary plants are in certain embodiments monocotyledonous or dicotyledonous plants such as alfalfa, barley, canola, corn, cotton, flax, kapok, peanut, potato, oat, rice, rye, sorghum, soybean, sugarbeet, sugarcane, sunflower, tobacco, tomato, wheat, turf grass, pasture grass, berry, fruit, legume, vegetable, ornamental plants, shrubs, cactuses, succulents, and trees.

In further illustrative embodiments, the plant may be any plant, including plants selected from the order Solanales, including plants from the following families: Convolvulaceae, Hydroleaceae, Montiniaceae, Solanaceae, and Sphenocleaceae, and plants from the order Asparagales, including plants from the following families: Amaryllidaceae, Asparagaceae, Asteliaceae, Blandfordiaceae, Boryaceae, Doryanthaceae, Hypoxidaceae, Iridaceae, Ixioliriaceae, Lanariaceae, Orchidaceae, Tecophilaeaceae, Xanthorrhoeaceae, and Xeronemataceae.

In various embodiments the mollusc is a gastropod mollusc, a terrestrial mollusc, such as a terrestrial gastropod mollusc, including a pulmonate gastropod mollusc, and a gilled or operculate mollusc.

Preferably, the one or more molluscs is selected from the land snails and slugs, including those of the clade Heterobranchia, the clade Opisthobranchia, and the clade Pulmonata.

To those skilled in the art to which the invention relates, many changes in construction and differing embodiments and applications of the invention will suggest themselves without departing from the scope of the invention as defined in the appended claims. The disclosures and the descriptions herein are purely illustrative and are not intended to be in any sense limiting.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

### DESCRIPTION OF FIGURES

FIG. 1 shows two chromatograms of compositions of the invention stored for 14 days at room temperature (FIG. 1A (top)) and at 54° C. (FIG. 1B (bottom)) as described herein in Example 1.

FIG. 2 shows an assay of bacteriological growth supported by a composition of the invention (A) compared to Teaex100 (B), as described herein in Example 1.

FIG. 3 shows the results of an assessment of the molluscicidal activity of an H₂O-control formulation at 5 days post treatment, as described herein in Example 5. The left hand side of the container was the non-treatment half, and the right hand side was the treatment half, in this case sprayed with water.

FIG. 4 shows the results of an assessment of the molluscicidal activity of a saponin-containing composition of the invention applied at the RTU-label rate at 5 days post treatment, as described herein in Example 5. The left hand side of the container was the non-treatment half, and the right hand side was the treatment half, in this case sprayed with water.

FIG. 5 shows the results of an assessment of the molluscicidal activity of an saponin-containing composition of the invention applied at two times the RTU-label rate at 5 days post treatment, as described herein in Example 5. The left hand side of the container was the non-treatment half, and the right hand side was the treatment half, in this case sprayed with water.

### DETAILED DESCRIPTION OF THE INVENTION

The present invention is in part directed to compositions comprising one or more saponins isolated from Camellia sinensis, and methods of preparing these compositions, wherein the compositions have efficacy against molluscs, including terrestrial molluscs, and also to the use of such compositions in controlling molluscs.

Definitions

The term “biological control agent” (BCA) as used herein refers to a biological agent which acts as an antagonist of one or more organisms, typically one or more pests or pathogens, such as one or more plant pests or phytopathogens, such as a terrestrial mollusc, or is able to control one or more one or more pests or pathogens such as one or more terrestrial molluscs. Antagonism may take a number of forms. In one form, the biological control agent may simply act as a repellent. In another form, the biological control agent may render the environment unfavourable for the pathogen. In a further, preferred form, the biological control agent may parasitise, incapacitate, render infertile, impede the growth of, impede the spread or distribution of, and/or kill the pest or pathogen.

Accordingly, the antagonistic mechanisms include but are not limited to antibiosis, parasitism, immobilisation, infertility, and toxicity. Therefore, agents which act as antagonists of one or more molluscs, including terrestrial molluscs, can be said to have molluscicidal efficacy. Furthermore, an agent that is an antagonist of a mollusc can be said to be a molluscicidal agent.

As used herein, a “biological control composition” is a composition comprising or including at least one biological control agent that is an antagonist of one or more pests or pathogens, such as one or more plant pests or phytopathogens. Such control agents include, but are not limited to, agents that act as repellents, agents that render the environment unfavourable for the pest or pathogen, and agents that incapacitate, render infertile, and/or kill the pest or pathogen.

Accordingly, as used herein an “anti-phytopathogenic composition” is a composition which comprises or includes at least one agent that is an antagonist of one or more phytopathogens. Such a composition is herein considered to have anti-phytopathogenic efficacy.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

The term “control” or “controlling” as used herein generally comprehends preventing, reducing, or eradicating infection by one or more pathogens such as infection by one or more phytopathogens, or inhibiting the rate and extent of such infection, such as reducing a phytopathogen population in or on a plant or its surroundings, wherein such prevention or reduction in the infection(s) or population(s) is statistically significant with respect to untreated infection(s) or population(s). Curative treatment is also contemplated. Preferably, such control is achieved by increased mortality amongst the pathogen population.

The phrases “molluscicidal activity” and “molluscicidal efficacy” are used interchangeably herein and refer to the ability of certain agents, such as saponins or saponin fractions to antagonise one or more molluscs, including terrestrial molluscs, such as one or more slugs or snails.

In various embodiments, said molluscicidal efficacy is the ability to parasitise or support parasitism of, incapacitate, render infertile, impede the growth of, or kill one or more molluscs, including terrestrial molluscs, preferably within 14 days of contact with the mollusc, more preferably within 7 days, more preferably still the ability to kill one or more molluscs, including terrestrial molluscs, or the ability to kill one or more molluscs within 7 days. For example, certain embodiments of the saponin or saponin fractions of the invention are molluscicidal.

Accordingly, as used herein a “molluscicidal composition” is a composition which comprises or includes at least one agent that is an antagonist of one or more molluscs, including terrestrial molluscs, or a composition which comprises or includes at least one saponin or saponin fractions or extacts of the invention having molluscicidal activity. Such a composition is herein considered to have molluscicidal efficacy. Particularly contemplated are molluscicidal compositions capable of repelling or killing one or more molluscs, and particularly compositions capable of repelling or killing one or more molluscs within about 7 days.

Methods and assays to determine molluscicidal efficacy are well known in the art, and include assays of the ability of a saponin of the invention to kill, repel, or otherwise antagonise a target mollusc. Two exemplary methods to determine molluscicidal activity are described herein in the Examples, and those skilled in the art will recognise modifications that can readily be made to the exemplified assay to suit a particular target mollusc population or a particular embodiment of the present invention. Molluscicidal compositions particulary contemplated in the present invention are those capable of killing, repelling, or otherwise antagonising a statistically significant proportion of the target mollusc or mollusc population when compared to control compositions, such as control compositions lacking a saponin or saponin fraction of the present invention.

The term “functional variant” as used herein in reference to one or more saponins or saponin fractions, for example in respect of one or more saponin fractions prepared according to the methods as exemplified herein in the Examples, refers to a saponin or saponin fraction different from the specifically identified entity, for example wherein one or more groups, such as one or more glycoside groups is deleted, substituted, or added, but which possesses at least in part one or more of the biological activities of the specifically-identified entity, such as an ability to elicit one or more biological effects elicited by the specifically-identified saponin or saponin fraction. Functional variants may be from the same or from other species and may encompass homologues, paralogues and orthologues.

In the present case, the functional variant will preferably retain at least a portion of the molluscicidal activity of the specifically-identified saponin or saponin fraction.

Methods and assays to determine one of more biological effects elicited by the compositions of the invention comprising one or more saponins or saponin fractions of the invention, such as molluscicidal efficacy, are well known in the art, and such methods and assays can be used to identify or verify one or more functional variants of one or more of the saponins or saponin fractions of the invention. For example, an assay of the ability of a saponin of the invention to kill or otherwise antagonise the growth of a target mollusc, such as those described herein in the Examples, is amenable to identifying one or more functional variants of the saponin.

The term “saponin”, as used herein, encompasses amphipathic glycosides comprising a carbohydrate moiety, typically a hydrophilic glycoside, glycosidically attached to a hydrophobic polycyclic aglycone, typically either a triterpene or a steroid or a derivative therefrom. Saponins are widely distributed amongst plants, but have also been isolated from marine organisms, and are recognized by a soap-like foaming when shaken in water or other aqueous solvents.

The term “saponin fraction”, as used herein, encompasses a composition comprising one or more saponins, wherein the fraction comprises or consists of a subset of the total molecules present in the unfractionated source material, such as a subset of the total saponins present in the unfractionated source material. Typically, saponin fractions will have a determinable and identifiable composition, for example a characteristic chromatography profile or mass spectragraphic profile. Examples of saponin fractions are presented herein.

The term “plant” as used herein encompasses not only whole plants, but extends to plant parts, cuttings as well as plant products including roots, leaves, flowers, seeds, stems, callus tissue, nuts and fruit, bulbs, tubers, corms, grains, cuttings, root stock, or scions, and includes any plant material whether pre-planting, during growth, and at or post harvest. Plants that may benefit from the application of the present invention cover a broad range of agricultural and horticultural crops. The compositions of the present invention are also especially suitable for application in organic production systems.

When used in respect of a molluscicidal agent, such as a molluscicidal saponin, the phrase “retaining molluscicidal efficacy” and grammatical equivalents and derivatives thereof is intended to mean that the agent still has useful molluscicidal activity. Preferably, the retained activity is at least about 35, 40, 45, 50, 55, 60, 65, 70, 75, 80, 85, 90, 95, 99 or 100% of the original activity, and useful ranges may be selected between any of these values (for example, from about 35 to about 100%, from about 50 to about 100%, from about 60 to about 100%, from about 70 to about 100%, from about 80 to about 100%, and from about 90 to about 100%). For example, preferred saponin functional variants or fractions of the present invention should retain molluscicidal activity, that is, retain at least about 35, 40, 45, 50, 55, 60, 65, 70, 75, 80, 85, 90, 95, 99 or 100% of the molluscicidal activity of the specified parent saponin or saponin fraction.

Accordingly, a functional variant of one of the saponin fractions described herein, such as a variant of the saponin fractions exemplified in the examples should retain at least about 35, 40, 45, 50, 55, 60, 65, 70, 75, 80, 85, 90, 95, 99 or 100% of the molluscicidal activity of the respective saponin fraction. Similarly, preferred compositions of the invention are capable of supporting the maintenance of useful molluscicidal activity of the molluscicidal agent (s) they comprise, and can be said to retain molluscicidal activity, ideally until applied using the methods contemplated herein.

As used herein, the term “stable” when used in relation to a composition of the invention means a composition capable of supporting molluscicidal efficacy for several weeks, preferably about one, about two, about three, about four, preferably about five, more preferably about six months, or longer.

The term “surroundings” when used in reference to a plant subject to the methods and compositions of the present invention includes soil, water, leaf litter, and/or growth media adjacent to or around the plant or the roots, tubers or the like thereof, adjacent plants, cuttings of said plant, supports, water to be administered to the plant, and coatings including seed coatings. It further includes storage, packaging or processing materials such as protective coatings, boxes and wrappers, and planting, maintenance or harvesting equipment.

Compositions of the Invention

The compositions of the invention comprise one or more saponins from Camellia sinensis, including one or more saponin fractions from Camellia sinensis.

Saponins comprise one or more hydrophilic glycoside moieties combined with a lipophilic aglycone, typically an organic polycyclic moiety such as a terpene or steroid or a derivative thereof. Saponins are typically classified by the number of glycosides attached to the aglycone (also referred to as a sapogenin), the number of glycoside chains attached to the aglycone, (e.g., monodesmosidic, bidesmosidic, etc), and the structure of each chain, whether linear or branched. Commonly, the glycoside chain(s) comprise monosaccharides, such as D-glucose and D-galactose.

In various embodiments the lipophilic aglycone is a polycyclic organic structure originating from the addition of terpene (C10) units to form a triterpene (C30) backbone. Subsequent derivitisation, for example to yield a C27 steroidal backbone is commonly seen.

Saponins are widely distributed in the natural environment, and are typically sourced from plants. Indeed, many plants containing significant amounts of saponins are popularly consumed food stuffs, including for example, green and black teas, alfalfa sprouts, various beans, and the like. Steroidal saponins are generally associated with monocotyledonous angiosperms, while triterpenoid saponins are generally associated with dicotyledonous angiosperms.

Triterpenoid saponins are reportedly present in the seeds, roots and flowers of the tea plant, Camellia sinensis. Youngmok K et al. report the extraction using chloroform of saponin fractions from tea made from the leaves of five varieties of teas from Ilex vomitoria and Camellia sinensis, with that from Ilex vomitoria having the highest concentration of saponins (Youngmok et al. “Determination of saponin and various chemical compounds in Camellia sinensis (2009) Senus Technical Note SEN-TN-0027).

The invention provides compositions comprising saponins from Camellia sinensis, for example for use as molluscicides, and methods for preparing these compositions.

In one embodiment, the invention relates to a saponin-comprising composition from Camellia sinensis, the composition comprising an aqueous extract from Camellia sinensis wherein the extraction is performed at

(a) greater than about 100° C.,

(b) greater than one atmosphere, or

(c) both (a) and (b).

In one embodiment, an exemplary composition of the invention, typically a concentrated composition has the following characteristics:

| | |
|---|---|
| Appearance | brown liquid |
| Odour | Warm overtones of sweet tea |
| Physical form | Liquid |
| Solubility | soluble in water |
| ph | 6.2 |
| Specific Gravity | 1.03 |
| Brix | 22 degree |
| [Saponin] | >150 g · L⁻¹ |
| Contaminants | No heavy metals |

Another embodiment of the invention relates to an exemplary ready-to-use composition having the following characteristics:

| | |
|---|---|
| Appearance | very light straw brown colour |
| Odour | odour, hardly detectable |
| Physical Form | Liquid |
| Solubility | soluble in water |
| pH | 3.9 to 4.1 |
| Specific Gravity | 1 |
| [Saponin] | approximately 1 g · L⁻¹ |

Exemplary compositions, as well as exemplary methods for preparing compositions of the invention are described herein, including in the Examples.

Control of Plant Pests or Phytopathogens

The present invention recognises that the horticultural sectors of many countries, including for example that of the United States of America, of New Zealand, and many states of Europe, are faced with the problem of increasing molluscicide resistance amongst plant pests. This is compounded under some regulatory regimes by a reduction in the availability of new chemical molluscicides due to regulatory barriers.

The use of molluscicidal saponins derived from Camellia sinensis as biological control agents presents a solution to this problem. Effective biological control agents can be selected according their ability to incapacitate or kill a target phytopathogenic mollusc or mollusc population. Under conducive conditions, molluscs, including terrestrial molluscs, such as snails or slugs may infest plants and their surroundings including soil, leaf litter, adjacent plants, supports, and the like. Molluscicidal saponins derived from Camellia sinensis and agents derived therefrom may be applied so as to incapacitate and/or kill the mollusc, thereby preventing or limiting the damage or disease-causing capability of the pest. The effectiveness of these molluscicidal compositions of the invention comprising saponins derived from Camellia sinensis in the field is partly due to their ability to retain molluscicidal efficacy in varying climatic conditions, such as interrupted wet periods and desiccation. As will be appreciated, the effectiveness of compositions derived from Camellia sinensis such as the compositions described herein requires a maintenance of molluscicidal efficacy. Again, as will be appreciated, the stability of the composition, such as for example a resistance to colonisation by contaminating microorganisms, an ability to suppress or not support the growth of microorganisms, or a bacteriostatic or fungistatic character, may all contribute to the utility of the composition and/or a maintainence of molluscicidal efficacy.

A composition, saponin or saponin fraction of the invention, effective against molluscs, including terrestrial molluscs, such as slugs and snails, and therefore suitable for use in accordance with the invention, is identified as one which is effective at reducing the population of the target mollusc species by a statistically significant amount with respect to the control treatment against which the compositions, saponins, or saponin fractions of the invention or functional variants thereof is compared. Such compositions, saponins or saponin fractions can be considered as having molluscicidal efficacy. As described herein, the reduction in the population of the target mollusc may be by various antagonistic mechanisms. For example, the composition may repel, incapacitate, render infertile, inhibit the growth or development of, and/or preferably kill the phytopathogenic mollusc, or may support or promote the molluscicidal efficacy of one or more molluscicides also present, such as a molluscicidal fungi or bacteria present in a composition together with the saponin or saponin fraction of the invention (whether separately, simultaneously, or sequentially). As such, the saponins or saponin fractions of the invention may enable or support the ability of the molluscicide such as a molluscicidal fungi or bacteria to parasitise, incapacitate, render infertile, and/or preferably kill the phytopathogenic mollusc. The saponins or saponin fractions of the invention may also reduce the population of the target mollusc by rendering the environment, for example the plant to which the composition of the invention is applied or its surroundings, unfavourable for the phytopathogenic mollusc. In this embodiment, the saponin or saponin fraction may be considered to be acting as a repellent, and reducing the effective population of the target mollusc in the vicinity of the plant or its surroundings.

Preferably, suitable compositions of the invention comprising saponins or saponin fractions or functional variants thereof exhibit about 5% molluscicidal efficacy, at least about 10%, at least about 15%, at least about 20%, at least about 25%, at least about 30%, at least about 35%, at least about 40%, at least about 45%, more preferably at least about 50% molluscicidal efficacy expressed as a percentage reduction of the population of the relevant mollusc species compared to the control treatment. By way of illustration, the methodology described herein can be employed to identify saponins or saponin fractions effective against a variety of target molluscs, including terrestrial molluscs, whereas procedures analogous to those described herein can be employed in relation to other compositions and mollusc species.

Although molluscicidal efficacy is a principal requisite for a composition of the invention comprising a saponin or saponin fraction to be considered suitable for use as a biological control agent, composition of the invention comprising a saponin or saponin fraction may have additional characteristics to be suitable for use as a biological control agent.

For example, the composition of the invention comprising a saponin or saponin fraction should be able to be stored in effective form for a reasonable period, ultimately so as to allow it to be applied to the target plant or its surroundings in a form and concentration that is effective as a biological control agent. Particularly contemplated are compositions of the invention capable of being stored for a reasonable period without supporting bacterial growth or thus contamination. Methods to assess such bacteriostatic compositions of the present invention, as well as methods to determine whether a composition of the present invention is bacteriocidal, are presented herein in the examples. Accordingly, molluscicidal compositions of the present invention that are bacteriostatic, or that are bacteriocidal, are particularly contemplated.

Those skilled in the art will recognise that the saponins or saponin fractions and compositions of the invention may comprise or the methods of the invention may use one or more functional variants of one or more of the saponins or saponin fractions of the invention including those exemplified herein. Combinations of saponins or saponin fractions and functional variants thereof are also useful herein.

Exemplary methods to produce and isolate one or more of the saponins or saponin fractions of the invention are described herein. These include isolation of one or more saponins or saponin fractions from Camellia sinensis or a tissue or extract thereof.

The present invention provides a composition which comprises one or more saponins or saponin fractions or functional variants thereof, together with one or more antiphytopathogenic agents, such as a fungi or bacteria and at least one carrier.

The composition may include multiple anti-phytopathogenic agents and in certain embodiments, multiple anti-phytopathogenic agents may be utilised to target a number of phytopathogenic species, or a number of different developmental stages of a single phytopathogen, or indeed a combination of same. For example, the pupal form of a mollusc may be targeted with one anti-phytopathogenic agent, such as one anti-phytopathogenic fungal strain, while the adult form of the mollusc may be targeted with another agent, such as another fungal strain, wherein both agents are included in a composition of the invention.

Examples of compositions comprising pesticidal or anti-phytopathogenic fungi are well known in the art, and include those described in, for example, PCT/US94/11542 (published as WO95/10597) to Mycotech Corporation, PCT/US2002/037218 (published as WO2003/043417) to The United States of America as represented by The Secretary of Agriculture, U.S. Pat. No. 4,530,834 to McCabe et al., U.S. patent application Ser. No. 10/657,982 (published as US 2004/0047841) to Wright et al., and PCT/NZ2009/000217 (published as WO2010/044680), each incorporated by reference herein in its entirety.

To be suitable for application to a plant or its surroundings, said at least one carrier is an agriculturally acceptable carrier, more preferably is selected from the group consisting of a filler stimulant, an anti-caking agent, a wetting agent, an emulsifier, and an antioxidant, more preferably said composition comprises at least one of each of a filler stimulant, an anti-caking agent, a wetting agent, an emulsifier, and an antioxidant. Preferably, said filler stimulant is a carbohydrate source, such as a disaccharide including, for example, sucrose, fructose, glucose, or dextrose, said anti-caking agent is selected from talc, silicon dioxide, calcium silicate, or kaelin clay, said wetting agent is skimmed milk powder, said emulsifier is a soy-based emulsifier such as lecithin or a vegetable-based emulsifier such as monodiglyceride, and said antioxidant is sodium glutamate or citric acid. However, other examples well known in the art may be substituted, provided the ability of the composition to support molluscicidal efficacy, and fungal viability where necessary, is maintained.

Preferably, said composition is a biological control composition. The concentration of the molluscicidal saponin or saponin fraction of the invention present in the composition that is required to be effective as biological control agents may vary depending on the end use, physiological condition of the plant; type (including mollusc species), concentration and degree of pathogen infection; temperature, season, humidity, stage in the growing season and the age of plant; number and type of conventional molluscicides or other treatments (including fungicides) being applied; and plant treatments (such as deleafing and pruning) may all be taken into account in formulating the composition.

Saponin Compositions and Methods of Use

The inventors contemplate that the saponin compositions disclosed herein will find particular utility as biological control compositions for topical and/or systemic application to, for example, field crops, grasses, fruits and vegetables, lawns, trees, and/or ornamental plants. Alternatively, the saponins disclosed herein may be formulated as a spray, dust, powder, or other aqueous, atomized or aerosol for killing a mollusc, or controlling a mollusc population. The saponin compositions disclosed herein may be used prophylactically, or alternatively, may be administered to an environment once target molluscs, including terrestrial molluscs, have been identified in the particular environment to be treated. The saponin compositions may comprise an individual saponin or may contain various combinations of the saponins disclosed herein.

Regardless of the method of application, the amount of the active saponin component(s) is applied at a molluscicidalally-effective amount, which will vary depending on such factors as, for example, the specific target molluscs, including terrestrial molluscs, to be controlled, the specific environment, location, plant, crop, or agricultural site to be treated, the environmental conditions, and the method, rate, concentration, stability, and quantity of application of the active saponin composition. The formulations may also vary with respect to climatic conditions, environmental considerations, and/or frequency of application and/or severity of mollusc infestation.

The compositions described may be made by formulating the one or more saponins or saponin fractions, optionally together with one or more other pesticides, with the desired agriculturally-acceptable carrier. The compositions may be formulated prior to administration in an appropriate means such as lyophilized, freeze-dried, desiccated, or in an aqueous carrier, medium or suitable diluent, such as water, saline or other buffer. The formulated compositions may be in the form of a liquid for direct application, a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art. The term “agriculturally-acceptable carrier” covers all adjuvants, inert components, dispersants, surfactants, tackifiers, binders, stickers, etc. that are ordinarily used in molluscicide formulation technology; these are well known to those skilled in molluscicide formulation. The formulations may be mixed with one or more solid or liquid adjuvants and prepared by various means, e.g., by homogeneously mixing, blending and/or grinding the molluscicidal composition with suitable adjuvants using conventional formulation techniques.

The compositions may include one or more fungal strains, may include one or more bacterial species, or both. Exemplary bacterial species include those such as B. thuringiensis, B. megaterium, B. subtilis, B. cereus, E. coli, Salmonella spp., Agrobacterium spp., or Pseudomonas spp.

Oil Flowable Suspensions

In one exemplary embodiment, the molluscicide composition comprises an oil flowable suspension of one or more saponins of the invention, functional variants or functional fragments thereof, optionally together with one or more pesticides.

Water-Dispersible Granules

In another important exemplary embodiment, the molluscicide composition comprises a water dispersible granule. This granule comprises one or more saponins of the invention, functional variants or functional fragments thereof, optionally together with one or more fungal cells, including one or more pesticides.

Powders, Dusts, and Spore Formulations

In a third important exemplary embodiment, the molluscicide composition comprises a wettable powder, dust, spore formulation, cell pellet, or colloidal concentrate. This powder comprises one or more saponins of the invention, functional variants or functional fragments thereof, optionally together with one or more pesticides. Such dry forms of the molluscicidal compositions may be formulated to dissolve immediately upon wetting, or alternatively, dissolve in a controlled-release, sustained-release, or other time-dependent manner. Such compositions may be applied to the target mollusc, and as such, may be used to control the numbers of molluscs, including terrestrial molluscs, or the spread of such molluscs, including terrestrial molluscs, in a given environment.

Aqueous Suspensions and Fungal Cell Filtrates or Lysates

In a fourth important exemplary embodiment, the molluscicide composition comprises an aqueous solution of one or more saponins of the invention, functional variants or functional fragments thereof, optionally together with one or more pesticides. Such aqueous solutions are in certain embodiments provided as a concentrated stock solution which is diluted prior to application, or alternatively, as a diluted solution ready-to-use.

In certain embodiments the molluscicidal compositions are formulated as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). Exemplary formulations also comprise spreader-sticker adjuvants, stabilizing agents, other pesticidal additives, or surfactants. Exemplary liquid formulations are aqueous-based or non-aqueous and employed as foams, suspensions, emulsifiable concentrates, or the like. Rheological agents, surfactants, emulsifiers, dispersants, or polymers are in certain embodiments also employed.

Multifunctional Formulations

In certain embodiments, for example those when the control of multiple mollusc species is desired, the molluscicidal formulations described herein may also further comprise one or more chemical pesticides, (such as chemical pesticides, nematocides, fungicides, virucides, microbicides, amoebicides, molluscicides, etc.), and/or one or more saponins or saponin fractions having the same, or different molluscicidal activities or molluscicidal specificities, as the molluscicidal saponins or saponin fractions described herein. The molluscicidal saponins or saponin fractions may also be used in conjunction with other treatments such as fertilizers, weed killers, cryoprotectants, surfactants, detergents, molluscicidal soaps, dormant oils, polymers, and/or time-release or biodegradable carrier formulations that permit long-term dosing of a target area following a single application of the formulation. Likewise the formulations may be prepared into edible “baits” or fashioned into mollusc “traps” to permit feeding or ingestion by a target mollusc of the molluscicidal formulation.

The molluscicidal compositions of the invention may also be used in consecutive or simultaneous application to an environmental site singly or in combination with one or more additional molluscicides, pesticides, chemicals, fertilizers, or other compounds.

In certain embodiments, the composition is a stable composition capable of supporting molluscicidal efficacy (for example, of one or more saponins) for a period greater than about two weeks, preferably greater than about one month, about two months, about three months, about four months, about five months, more preferably greater than about six months.

The composition of the invention may also include one or more carriers, preferably one or more agriculturally acceptable carriers. In one embodiment the carrier, such as an agriculturally acceptable carrier, can be solid or liquid. Carriers useful herein include any substance typically used to formulate agricultural composition.

In one embodiment the agriculturally acceptable carrier maybe selected from the group comprising fillers, solvents, excipients, surfactants, suspending agents, speaders/stickers (adhesives), antifoaming agents, dispersants, wetting agents, drift reducing agents, auxiliaries, adjuvants or a mixture thereof.

Compositions of the invention may be formulated as, for example, concentrates, solutions, sprays, aerosols, immersion baths, dips, emulsions, wettable powders, soluble powders, suspension concentrates, dusts, granules, water dispersible granules, microcapsules, pastes, gels and other formulation types by well-established procedures.

These procedures include mixing and/or milling of the active ingredients with agriculturally acceptable carrier substances, such as fillers, solvents, excipients, surfactants, suspending agents, speaders/stickers (adhesives), antifoaming agents, dispersants, wetting agents, drift reducing agents, auxiliaries and adjuvants.

In one embodiment solid carriers include but are not limited to mineral earths such as silicic acids, silica gels, silicates, talc, kaolin, attapulgus clay, limestone, lime, chalk, bole, loess, clay, dolomite, diatomaceous earth, aluminas calcium sulfate, magnesium sulfate, magnesium oxide, ground plastics, fertilizers such as ammonium sulfate, ammonium phosphate, ammonium nitrate, and ureas, and vegetable products such as grain meals, bark meal, wood meal, and nutshell meal, cellulosic powders and the like. As solid carriers for granules the following are suitable: crushed or fractionated natural rocks such as calcite, marble, pumice, sepiolite and dolomite; synthetic granules of inorganic or organic meals; granules of organic material such as sawdust, coconut shells, corn cobs, corn husks or tobacco stalks; kieselguhr, tricalcium phosphate, powdered cork, or absorbent carbon black; water soluble polymers, resins, waxes; or solid fertilizers. Such solid compositions may, if desired, contain one or more compatible wetting, dispersing, emulsifying or colouring agents which, when solid, may also serve as a diluent.

In one embodiment the carrier may also be liquid, for example, water; alcohols, particularly butanol or glycol, as well as their ethers or esters, particularly methylglycol acetate; ketones, particularly acetone, cyclohexanone, methylethyl ketone, methylisobutylketone, or isophorone; petroleum fractions such as paraffinic or aromatic hydrocarbons, particularly xylenes or alkyl naphthalenes; mineral or vegetable oils; aliphatic chlorinated hydrocarbons, particularly trichloroethane or methylene chloride; aromatic chlorinated hydrocarbons, particularly chlorobenzenes; water-soluble or strongly polar solvents such as dimethylformamide, dimethyl sulfoxide, or N-methylpyrrolidone; liquefied gases; or the like or a mixture thereof.

In one embodiment surfactants include nonionic surfactants, anionic surfactants, cationic surfactants and/or amphoteric surfactants and promote the ability of aggregates to remain in solution during spraying.

Spreaders/stickers promote the ability of the compositions of the invention to adhere to plant surfaces. Examples of surfactants, spreaders/stickers include but are not limited to Tween and Triton (Rhom and Hass Company), Deep Fried™, Fortune®, Pulse, C. Daxoil®, Codacide oil®, D-C. Tate®, Supamet Oil, Bond®, Penetrant, Glowelt® and Freeway, Citowett®, Fortune Plus™, Fortune Plus Lite, Fruimec, Fruimec lite, alkali metal, alkaline earth metal and ammonium salts of aromatic sulfonic acids, e.g., ligninsulfonic acid, phenolsulfonic acid, naphthalenesulfonic acid and dibutylnaphthalenesulfonic acid, and of fatty acids, alkyl and alkylaryl sulfonates, and alkyl, lauryl ether and fatty alcohol sulfates, and salts of sulfated hexadecanols, heptadecanols, and octadecanols, salts of fatty alcohol glycol ethers, condensation products of sulfonated naphthalene and naphthalene derivatives with formaldehyde, condensation products of naphthalene or naphthalenesulfonic acids with phenol and formaldehyde, polyoxyethylene octylphenol ethers, ethoxylated isooctylphenol, ethoxylated octylphenol and ethoxylated nonylphenol, alkylphenol polyglycol ethers, tributylphenyl polyglycol ethers, alkylaryl polyether alcohols, isotridecyl alcohol, fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methyl cellulose. Where selected for inclusion, one or more agricultural surfactants, such as Tween are desirably included in the composition according to known protocols.

Wetting agents reduce surface tension of water in the composition and thus increase the surface area over which a given amount of the composition may be applied. Examples of wetting agents include but are not limited to salts of polyacrylic acids, salts of lignosulfonic acids, salts of phenolsulfonic or naphthalenesulfonic acids, polycondensates of ethylene oxide with fatty alcohols or fatty acids or fatty esters or fatty amines, substituted phenols (particularly alkylphenols or arylphenols), salts of sulfosuccinic acid esters, taurine derivatives (particularly alkyltaurates), phosphoric esters of alcohols or of polycondensates of ethylene oxide with phenols, esters of fatty acids with polyols, or sulfate, sulfonate or phosphate functional derivatives of the above compounds.

In one embodiment the preferred method of applying the compound or composition of the invention is to spray a dilute or concentrated solution by handgun or commercial airblast.

As described above, the compositions of the present invention may be used alone or in combination with one or more other agricultural agents, including pesticides, molluscicides, acaracides, fungicides bactericides (provided such fungicides or bactericides are not detrimental or toxic to any fungi or bacteria present in the composition), herbicides, antibiotics, antimicrobials, nemacides, rodenticides, molluscicides, pheromones, attractants, plant growth regulators, plant hormones, mollusc growth regulators, chemosterilants, microbial pest control agents, repellents, viruses, phagostimulents, plant nutrients, plant fertilisers and biological controls. When used in combination with other agricultural agents the administration of the two agents may be separate, simultaneous or sequential. Specific examples of these agricultural agents are known to those skilled in the art, and many are readily commercially available.

Examples of plant nutrients include but are not limited to nitrogen, magnesium, calcium, boron, potassium, copper, iron, phosphorus, manganese, molybdenum, cobalt, boron, copper, silicon, selenium, nickel, aluminum, chromium and zinc.

Examples of antibiotics include but are not limited to oxytetracyline and streptomycin.

Examples of fungicides include but are not limited to the following classes of fungicides: carboxamides, benzimidazoles, triazoles, hydroxypyridines, dicarboxamides, phenylamides, thiadiazoles, carbamates, cyano-oximes, cinnamic acid derivatives, morpholines, imidazoles, beta-methoxy acrylates and pyridines/pyrimidines.

Further examples of fungicides include but are not limited to natural fungicides, organic fungicides, sulphur-based fungicides, copper/calcium fungicides and elicitors of plant host defences.

Examples of natural fungicides include but are not limited to whole milk, whey, fatty acids or esterified fatty acids.

Examples of organic fungicides include but are not limited to any fungicides which passes an organic certification standard such as biocontrol agents, natural products, elicitors (some of may also be classed as natural products), and sulphur and copper fungicides (limited to restricted use).

An example of a sulphur-based fungicide is Kumulus™ DF (BASF, Germany).

An example of a copper fungicide is Kocide® 2000 DF (Griffin Corporation, USA).

Examples of elicitors include but are not limited to chitosan, Bion™, BABA (DL-3-amino-n-butanoic acid, β-aminobutyric acid) and Milsana™ (Western Farm Service, Inc., USA).

In some embodiments non-organic fungicides may be employed. Examples of non-organic fungicides include but are not limited to BravoTM (for control of PM on cucurbits); Supershield™ (Yates, NZ) (for control of Botrytis and PM on roses); Topas® 200EW (for control of PM on grapes and cucurbits); Flint™ (for control of PM on apples and cucurbits); Amistar® WG (for control of rust and PM on cereals); and Captan™, Dithane™, Euparen™, Rovral™, Scala™, Shirlan™, Switch™ and Teldor™ (for control of Botrytis on grapes).

Examples of pesticides include but are not limited to azoxystrobin, bitertanol, carboxin, Cu₂O, cymoxanil, cyproconazole, cyprodinil, dichlofluamid, difenoconazole, diniconazole, epoxiconazole, fenpiclonil, fludioxonil, fluquiconazole, flusilazole, flutriafol, furalaxyl, guazatin, hexaconazole, hymexazol, imazalil, imibenconazole, ipconazole, kresoxim-methyl, mancozeb, metalaxyl, R-metalaxyl, metconazole, oxadixyl, pefurazoate, penconazole, pencycuron, prochloraz, propiconazole, pyroquilone, SSF-109, spiroxamin, tebuconazole, thiabendazole, tolifluamid, triazoxide, triadimefon, triadimenol, triflumizole, triticonazole and uniconazole.

An example of a biological control agent other than a fungal strain described herein is the BotryZen™ biological control agent comprising Ulocladium oudemansii.

The compositions may also comprise a broad range of additives such as stablisers and penetrants used to enhance the active ingredients and so-called ‘stressing’ additives to improve spore vigor, germination and survivability such as potassium chloride, glycerol, sodium chloride and glucose. Additives may also include compositions which assist in maintaining microorganism viability in long term storage, for example unrefined corn oil and so called invert emulsions containing a mixture of oils and waxes on the outside and water, sodium alginate and conidia on the inside.

As will be appreciated by those skilled in the art, it is important that any additives used are present in amounts that do not interfere with the effectiveness of the composition.

Examples of suitable compositions including carriers, preservations, surfactants and wetting agents, spreaders, and nutrients are provided in U.S. Pat. No. 5,780,023, incorporated herein in its entirety by reference.

The Applicants have also determined that many pesticidal microorganisms do not adversely affect the molluscicidal activity of the composition when present. The compositions of the invention may therefore also include such pesticidal microorganisms, such as pesticidal bacteria or fungi. Alternatively, the compositions may be used separately but in conjunction with such pesticidal microorganisms in control programmes.

The invention thus also provides a method of producing a composition comprising one or more saponins or saponin fractions of the invention or one or more functional variants thereof and one or more pesticidal microorganisms, such as pesticidal bacteria or fungi, including those described herein, said method comprising providing a reproductively viable form of said pesticidal microorganism and combining said reproductively viable form with one or more saponins or saponin fractions of the invention or functional variants thereof and at least one agriculturally acceptable carrier.

The compositions may be prepared in a number of forms. One preparation comprises a powdered form of a composition of the invention which may be dusted on to a plant or its surroundings. In a further form, the composition is mixed with a diluent such as water to form a spray, foam, gel or dip and applied appropriately using known protocols. In a presently preferred embodiment, a composition formulated as described above is mixed with water using a pressurised sprayer at about 1 gm/L, or about 1 to 3 kg/ha in no less than 1000 L water per ha. Preferably, Deep Fried™ or Fortune Plus™ is added to the composition as a UV and desiccation protection agent at about 1 ml/L. Compositions comprising Beauvaria bassiana, L. muscarium, L. longisporum, or P. fumosoroseus can be applied in a similar manner.

Compositions formulated for other methods of application such as injection, rubbing or brushing, may also be used, as indeed may any known art method. Indirect applications of the composition to the plant surroundings or environment such as soil, water, or as seed coatings are specifically contemplated.

As discussed above, the concentration at which the compositions of the invention are to be applied so as to be effective may vary depending on the end use, physiological condition of the plant; type, concentration and degree of pest infection; temperature, season, humidity, stage in the growing season and the age of plant; number and type of conventional molluscicides or other treatments being applied; and plant treatments (such as leaf plucking and pruning).

Other application techniques, including dusting, sprinkling, soil soaking, soil injection, seed coating, seedling coating, foliar spraying, aerating, misting, atomizing, fumigating, aerosolizing, and the like, are also feasible and may be required under certain circumstances, such as e.g., molluscs, including terrestrial molluscs, that cause root or stalk infestation, or for application to delicate vegetation or ornamental plants. These application procedures are also well-known to those of skill in the art.

The molluscicidal compositions of the present invention may also be formulated for preventative or prophylactic application to an area, and may in certain circumstances be applied to pets, livestock, animal bedding, or in and around farm equipment, barns, domiciles, or agricultural or industrial facilities, and the like.

The concentration of molluscicidal composition which is used for environmental, systemic, topical, or foliar application will vary widely depending upon the nature of the particular formulation, means of application, environmental conditions, and degree of biocidal activity. Typically, the molluscicidal composition will be present in the applied formulation at a concentration of at least about 1% by weight and may be up to and including about 99% by weight. Dry formulations of the saponin-comprising compositions may be from about 0.1% to about 99% or more by weight of the saponin or saponin fraction composition, and liquid formulations may generally comprise from about 0.01% to about 99% or more of the active ingredient by weight. As such, a variety of formulations are preparable, including those formulations that comprise from about 0.05% to about 95% or more by weight of the saponin or saponin fraction composition, including those formulations that comprise from about 0.1% to about 90% or more by weight of the saponin or saponin fraction composition. Naturally, compositions comprising from about 0.1% to about 10% or more by weight of the molluscicidal saponin or saponin fraction composition, and formulations comprising from about 0.1% to about 5% or more by weight of the molluscicidal saponin or saponin fraction composition are also considered to fall within the scope of the present disclosure.

The molluscicidal formulation described above may be administered to a particular plant or target area in one or more applications as needed, with a typical field application rate per hectare ranging on the order of from about 50 g/hectare to about 10 kg/hectare of active ingredient. In certain instances, it may be desirable to apply the molluscicidal formulation to a target area at an application rate of from about 1000 g/hectare to about 20 kg/hectare or more of active ingredient. In fact, all application rates in the range of from about 50 g of active saponin per hectare to about 20 kg/hectare are contemplated to be useful in the management, control, and killing, of target mollusc pests using such molluscicidal formulations. As such, rates of about 100 g/hectare, about 200 g/hectare, about 300 g/hectare, about 400 g/hectare, about 500 g/hectare, about 600 g/hectare, about 700 g/hectare, about 800 g/hectare, about 900 g/hectare, about 1 kg/hectare, about 1.1 kg/hectare, about 1.2 kg/hectare, about 1.3 kg/hectare, about 1.4 kg/hectare, about 1.5 kg/hectare, about 1.6 kg/hectare, about 1.7 kg/hectare, about 1.8 kg/hectare, about 1.9 kg/hectare, about 2.0 kg/hectare, about 2.5 kg/hectare, about 3.0 kg/hectare, about 3.5 kg/hectare, about 4.0 kg/hectare, about 4.5 kg/hectare, about 6.0 kg/hectare, about 7.0 kg/hectare, about 8.0 kg/hectare, about 8.5 kg/hectare, about 9.0 kg/hectare, and even up to and including about 10.0 kg/hectare or greater of active saponin or saponin fraction may be utilized in certain agricultural, industrial, and domestic applications of the pesticidal formulations described herein.

Representative application rates for liquid compositions include application rates in the range of from about 50 mL of active saponin per hectare to about 20 L/hectare are contemplated to be useful in the management, control, and killing, of target mollusc pests using such molluscicidal formulations. As such, rates of about 100 mL/hectare, about 200 mL/hectare, about 300 mL/hectare, about 400 mL/hectare, about 500 mL/hectare, about 600 mL/hectare, about 700 mL/hectare, about 800 mL/hectare, about 900 mL/hectare, about 1 L/hectare, about 1.1 L/hectare, about 1.2 L/hectare, about 1.3 L/hectare, about 1.4 L/hectare, about 1.5 L/hectare, about 1.6 L/hectare, about 1.7 L/hectare, about 1.8 L/hectare, about 1.9 L/hectare, about 2.0 L/hectare, about 2.5 L/hectare, about 3.0 L/hectare, about 3.5 L/hectare, about 4.0 L/hectare, about 4.5 L/hectare, about 6.0 L/hectare, about 7.0 L/hectare, about 8.0 L/hectare, about 8.5 L/hectare, about 9.0 L/hectare, and even up to and including about 10.0 L/hectare or greater of active saponin or saponin fraction may be utilized.

In one embodiment using an saponin-containing composition prepared using an exemplary method of preparation of the invention as described herein in the Examples, the composition is applied to ornamentals, seedlings, grass and lawns, lettuce or mescalin, strawberries, fruiting trees, or vegetables at a rate of, for example, 500 mL/100 L, at 2L/hectare.

In a further aspect the present invention provides a method for controlling one or more molluscs, including terrestrial molluscs, the method comprising applying to a plant or its surroundings a saponin or saponin fraction as described herein.

Young seedlings are typically most susceptible to damage from terrestrial molluscs such as slugs and snails. Therefore, application of the compositions of the invention to freshly planted out crops, prior to emergence, is contemplated, as is application on emergence.

Repeated applications at the same or different times in a crop cycle are also contemplated. The molluscicidal saponins of the invention, compositions comprising the molluscicidal saponins of the invention may be applied either earlier or later in the season. This may be over flowering or during fruiting. The molluscicidal compositions of the invention may also be applied immediately prior to harvest, or after harvest to rapidly colonise necrotic or senescing leaves, fruit, stems, machine harvested stalks and the like to prevent mollusc colonisation. The molluscicidal compositions of the invention may also be applied to dormant plants in winter to slow mollusc growth on dormant tissues.

Application may be at a time before or after bud burst and before and after harvest. However, treatment preferably occurs between flowering and harvest. To increase efficacy, multiple applications (for example, 2 to 6 applications over the stages of flowering through fruiting) of the molluscicidal saponins of the invention or a composition of the invention is preferred.

Reapplication of the molluscicidal saponins of the invention or composition should also be considered after rain. Using mollusc infectivity prediction models or infection analysis data, application of the composition can also be timed to account for mollusc infection risk periods. For example, application in early morning or evening, when slugs or snails are more likely to infest plants, should be considered.

In various exemplary embodiments, the saponins or saponin fractions of the present invention and compositions comprising such saponins or saponin fractions are not deleterious to the plants or plant surroundings to which they are applied at dosage rates capable of achieving molluscicidal efficacy.

In the presently preferred embodiments, the molluscicidal saponins of the invention or a composition comprising same is applied in a solution, for example as described above, using a pressurised sprayer. The plant parts should be lightly sprayed until just before run off, ideally to ensure thorough coverage. Applications may be made to any part of the plant and/or its surroundings, for example to the whole plant canopy, to the area in the canopy where the flowers and developing fruit are concentrated, or to the plant stem and/or soil, water or growth media adjacent to or surrounding the roots, tubers or the like.

Preferably the composition is stable. As used herein, the term “stable” refers to a composition capable of supporting molluscicidal efficacy for several weeks, preferably about one, about two, about three, about four, preferably about five, more preferably about six months, or longer. Preferably, the composition is stable without a requirement for storage under special conditions, such as, for example, refrigeration or freezing.

The applied compositions control molluscs, including terrestrial molluscs. Molluscs, including terrestrial molluscs, are responsible for much of the pre-harvest loss of plant parts and reduce growth rate, flowering, fruiting, production and may cause death of afflicted plants. As used herein, molluscs, including terrestrial molluscs, which are themselves plant pests or pathogens, and molluscs which may act as a vector for other plant pathogens, for example, phytopathogenic fungi and bacteria. It will be appreciated that by controlling host molluscs which act as vectors for other phytopathogens, the incidence and/or severity of plant disease can be minimised.

The methods of the invention have particular application to plants and plant products, either pre- or post-harvest. For example, the composition of the invention may be applied to stored products of the type listed above including fruits, vegetables, cut flowers and seeds. Suitable application techniques encompass those identified above, particularly spraying.

The composition can potentially be used to treat or pretreat soils or seeds, as opposed to direct application to a plant. The composition may find use in plant processing materials such as protective coatings, boxes and wrappers.

Also encompassed by the present invention are plants, plant products, soils and seeds treated directly with a saponin of the invention or a composition of the invention.

The invention consists in the foregoing and also envisages constructions of which the following gives examples only and in no way limit the scope thereof.

### EXAMPLE ONE

### Stability Test and Comparative Bacteriological Growth Study

This example describes an assessment of the long term shelf-life and stability and the resistance to bacteriological contamination of exemplary compositions of the invention.

### Methods

Preparation of Concentrated Composition

90 L of prepared concentrated saponin-containing composition of the invention was prepared as described below.

A 140 L 316 stainless pressure vessel (vessel) was pre sterilised with the addition of silver stabilised hydrogen peroxide, then drained and flushed with sterile water. 50 kg of Camellia sinensis Tea Seed Cake (Challenge Bioproducts Co., Ltd, Taiwan) was added into the vessel, and slowly hydrated with regular vigorous stirring with sterile water into a slurry. The volume was brought up to 110 L with sterile water, and the top of the vessel was bolted down.

The vessel was then heated to boiling point, sealed to increase the pressure and maintained at 1.3 Bar at 110° C. for 1 hour. The vessel was then turned off and allowed to cool down until ambient temperature was achieved at 0.3 bar. The vessel was then left for 24 hrs to steep.

After this period, the vessel was vented, drained to remove supernatant and to compress the tea cake solids to remove as much of the liquid as possible. The solids were then discarded, while the recovered supernatant was prefiltered to 50 μm, cross-flow filtered to remove all particulates, then stabilised with the addition of 0.1% acetic acid.

Sample Preparation:

Two 1 L samples of concentrated composition were aliquoted into 1 L glass Schott flasks. One sample was labelled “Before” and kept within the laboratory for 14 days at 18° C., the mean average temperature of the laboratory. The second sample was labelled “After” and was placed into a calibrated laboratory oven at 54° C. for 14 days.

Samples were filtered to 0.2 μm through a syringe filter prior to subsequent use and analysis.

Instrumental Analysis:

Samples were analysed by liquid chromatography mass spectrometry with inline diode array detection (LC-DAD-MS), using the instrument conditions outlined below in Table 1 and the HPLC conditions outlined in Table 2.

TABLE 1
Instrument conditions

| Parameter | Description/composition |
|---|---|
| Column | Waters Acquity C18 BEH 1.7 μM, |
| | 50 × 1 mm |
| Mobile phase | A - 0.1% formic acid in water |
| | B - 0.1% formic acid in acetonitrile |
| Flow rate | 250 μL/min |
| Injection volume | 5 μL |
| Column oven | 40° C. |
| Mass Lynx MS Tune file | Pos_scan.ipr |
| Ionisation mode | ESI+ and ESI− |
| Cone gas flow | 100 L/hr |
| Desolvation gas flow | 900 L/hr |
| Desolvation temperature | 350° C. |
| Source temperature | 100° C. |
| Capillary | 2.5 kV |
| Cone | 45 V |
| Mass Lynx MS Experiment file | −VE SCAN, +VE SCAN |
| Mode | −ESI and +ESI |
| Mass scan range | 400-1500 amu |
| Diode array | 190-400 nm |

TABLE 2
HPLC gradient conditions

| | | | Flow rate | |
|---|---|---|---|---|
| Time (min) | % A | % B | μL/min | Gradient |
| 0 | 100 | 0 | 250 | Initial |
| 2 | 100 | 0 | 250 | Linear |
| 10 | 0 | 100 | 250 | Linear |
| 12 | 0 | 100 | 250 | Linear |
| 12.2 | 100 | 0 | 250 | Linear |
| 13.5 | 100 | 0 | 250 | Linear |

### Bacteriological Study

Ready-To-Use Formulation of the Invention

5 mL of the concentrated composition of the invention was placed into 995 mL of sterile water. A single 25 mL aliquot of this solution was placed into a sterile petri dish and labelled as control. The remainder of the solution was inoculated with Pseuodomonas syringae and built to 10⁴ cfu/mL using a haemocytometer.

25 mL aliquots of this solution were placed into 9 sterile petri dishes. All petri dishes were placed into an incubator and incubated for 48 hrs at 30° C. After 48 hrs, samples were analysed using haemocytometer for determining increases in cfu/mL. Samples were analyzed for vigor and looped and plated onto plate count agar (PCA) to measure viability.

Teaex 100

5 mL of concentrated Teaex 100 (Challenge Bioproducts Co., Ltd, Taiwan) was placed into 995 mL of sterile water. A single 25mL aliquot of this solution was placed into a sterile petri dish and labelled as control. The remainder of the solution was inoculated with Pseuodomonas syringae and built to 10⁴ cfu/mL using a haemocytometer.

25 mL aliquots of this solution were placed into 9 sterile petri dishes. All petri dishes were placed into an incubator and incubated for 48 hrs at 30° C. After 48 hrs, samples were analysed using haemocytometer for determining increases in cfu/mL. Samples were analyzed for vigor and looped and plated onto plate count agar (PCA) to measure viability.

### Results

Accelerated Shelf Life Study

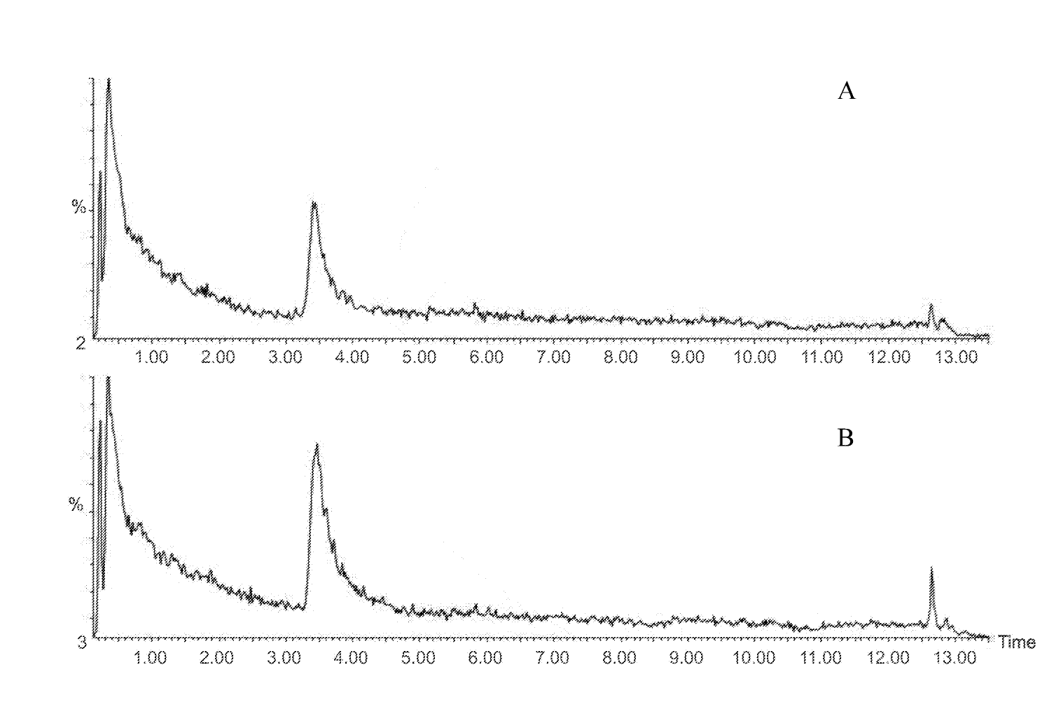

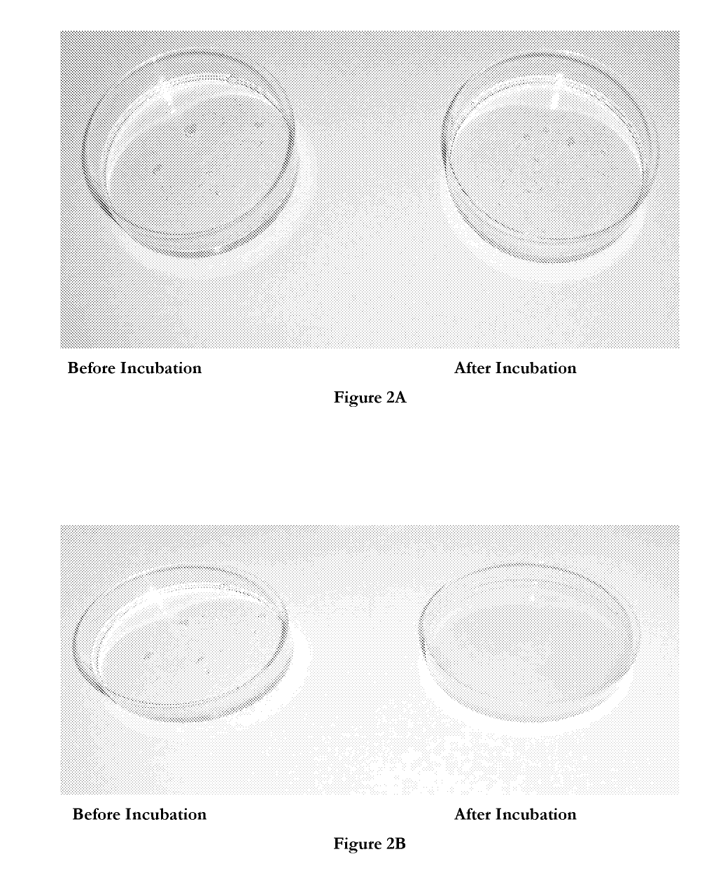

As shown in FIG. 1, there was little observable difference between the “Before” (FIG. 1A) and “After” (FIG. 1B) samples, apart from an apparent concentration difference. The LC-MS-DAD analysis showed the “After” sample had larger peaks (see FIG. 1B compared to FIG. 1A) and it was noted that the “After” sample was also darker in colour by visual inspection. The apparent difference in concentration was most likely due to evaporation during shelf life testing.

### Comparative Bacteriological Study

Saponin-Containing Composition of the Invention

On examination using haemocytometer, cfu/mL in the composition of the invention showed no increase and remained at the original inoculation rate of 1×10⁴ cfu/mL. There was a lack of vigour with significant mortality under stereoscopic examination.

If removed from the composition of the invention, live colonies did grow on PCA and quickly took over the plates under incubation at 30° C.

Teaex 100

Growth was easily noticed on examination of aliquot plates with a visual change in turbidity of the solution and a noticeable odour often associated with Pseudomonas syringae cultures. Haemocytometer confirmed a significant increase in population with 4×10⁸ cfu/mL recorded after 48 hrs. No lack of vigor was noticed and slides were used as teaching aids to staff in how to recognize Pseudomonas syringae as a possible contaminant. PCA growth plates were deemed unnecessary to confirm viability, due to the vigour of the bacteria under stereoscopic examination.

### Discussion

The results of this investigation suggest that the preparative methods of the invention produce a composition that is bacteriostatic, and does not support the growth of bacteria, even when bacteria are introduced at significant rates. This characteristic is not observed in compositions prepared by other methods, such as those involving extraction with organic solvents.

The bacteriological study described herein supports a noticeable difference in 25 bacteriological stability observed among various saponin-containing extracts from Camellia sinensis Tea Cake. Without wishing to be bound by any theory, the applicants believe that the extraction solvent, method, and conditions may individually or synergistically contribute to the desirable characteristics of the resulting composition, including for example, its bacteriological stability.

### EXAMPLE TWO

### Concentrate Formulation

This example describes the preparation of a concentrated saponin-containing composition of the invention, suitable for bulk distribution and application, or reformulation as a ready-to-use formulation.

### Method

A 140 L 316 stainless pressure vessel (vessel) is pre sterilised with the addition of silver stabilised hydrogen peroxide, then drained and flushed with sterile water. 50 kg of Camellia sinensis Tea Seed Cake (Challenge Bioproducts Co., Ltd, Taiwan) is added into the vessel, and slowly hydrated with regular vigorous stirring with sterile water into a slurry. The volume is brought up to 110 L with sterile water, and the top of the vessel is bolted down.

The vessel is then heated to boiling point, sealed to increase the pressure and maintained at 1.3 Bar at 110° C. for 1 hour. The vessel is then turned off and allowed to cool down until ambient temperature is achieved at 0.3 bar. The vessel is then left for 24 hrs to steep.

After this period, the vessel is vented, drained to remove supernatant and to compress the tea cake solids to remove as much of the liquid as possible. The solids are then discarded, while the recovered supernatant is prefiltered to 50 μm, cross-flow filtered to remove all particulates, then stabilised with the addition of 0.1% acetic acid or 0.1% sodium benzoate.

The concentrated saponin-containing composition of the invention is then packed out for distribution in 5, 10, 20, 25 or 200 litre lots in HDPE injected molded containers with a tamperproof cap to meet UN Packing Group III specification.

### EXAMPLE THREE

### Ready to Use Formulation

This example describes the preparation of a ready-to-use saponin-containing composition of the invention, suitable for immediate use by, for example, the home gardener.

### Methods

A concentrated saponin-containing composition of the invention is prepared as described above in Example 2 and stored in 5, 10, 20, 25 or 200 litre lots in HDPE injected molded containers with a tamperproof cap to meet UN Packing Group III specification.

The concentrated product is mixed with clean potable water to the concentration required for the RTU formulation, typically 5 mL of stabilised concentrate is diluted to 1 L with sterile water. The diluted ready-to-use formulation is stabilised with the addition of citric acid to pH 4.1, and then packed out in 750 mL or 1 L HDPE containers, usually with an incorporated trigger spray applicator, such as a spray bottle, along with instructions for use.

### Use

The ready-to-use (RTU) product is suitable for purchase by home gardeners. The product is applied as a ground spray to seedling and young crops when they are most susceptible to attack from slugs and snails. Instructions for use direct the gardener to apply a thin film of the active ingredient across the ground and over the seedling plant so the slug or snail comes into contact with the product, at which point the saponin active ingredient has a characteristic detergent effect on the soft body membrane of the molluscs, ultimately leading to death of the mollusc.

### EXAMPLE FOUR

### Assay of Molluscididal Activity

This example describes a method to assess the molluscicidal efficacy of a ready-to-use saponin-containing composition of the invention.

### Methods

The RTU formulation (5 mL of stabilised concentrate diluted to 1 L with sterile water) described in Example 3 above is sprayed on 5 separate 1 m×1 m plots of lettuce seedlings, planted at typical spacings as recommended by the seed producer. A control formulation comprising sterile water to which has been added citric acid to pH 4.1 is sprayed on 5 identical control plots. A Teaex 100 formulation as described in Example 1 is sprayed on a further 5 identical plots.

30 adult snails are introduced to the centre of each plot. The number of living snails remaining in each plot is assessed at 30 minutes, 1 hour, and hourly thereafter for the first 24 hours, and 6 hourly thereafter for two further days.

### Results

A decrease in the number of living snails still resident in the test plots, compared to the control plots, is indicative of the molluscicidal activity of the RTU formulation. Similarly, a greater decrease in the number of living snails still resident in the test plots, compared to the Teaex 100 control plots, is indicative of the improved molluscicidal activity of the RTU formulation compared to that of the Teaex 100 formulation.

### EXAMPLE FIVE

### Assay of Molluscicidal Activity

This example describes an assessment of the molluscicidal efficacy of various ready-to-use saponin-containing compositions of the invention.

### Materials and Methods

Approximately 5 cm potting compost was added to the bottom of 3 plastic containers. One cabbage, one bean, and one lettuce were then planted at one end of each container. The opposite, non-treatment end was covered with protecting cloth, and the planted end, including the compost, cabbage, bean and lettuce, was then sprayed with the trial compositions as follows.

1. Container 1 sprayed with 2.8 ml water only;

2. Container 2 sprayed with 2.8 ml RTU solution (212 g saponins per L) at the label rate (500 ml concentrate/100 Litre=5 ml/L, where 2 L concentrate/Ha=0.04 L diluted spray/m²);

3. Container 3 sprayed with 2.8 ml RTU solution at 2× label rate.

The non-treatment end was then uncovered and one bean, one cabbage and one lettuce were planted.

Eight to nine snails [Brown garden snail Cantareus aspersus (Müller) (Helix aspersa)] were then placed in the centre of each container, just to the non-treated side of the centre line. The top of the containers was then covered with film wrap and the lid to ensure as little water loss as possible occurred to ensure the compost and containers remained damp.

### Results

1. Container 1—H₂O Control

Day 1—Three of the eight snails moved to sprayed half of container and some cabbage and lettuce were eaten.

Day 5—Beans and lettuce were damaged at both the treatment and the non-treatment ends of the container. The lettuce was completely gone from the non-sprayed end (FIG. 3, left hand side of container).

2. Container 2—Label Rate

Day 1—All snails avoided the sprayed half of container and ate some cabbage and lettuce on the non-treatment side.

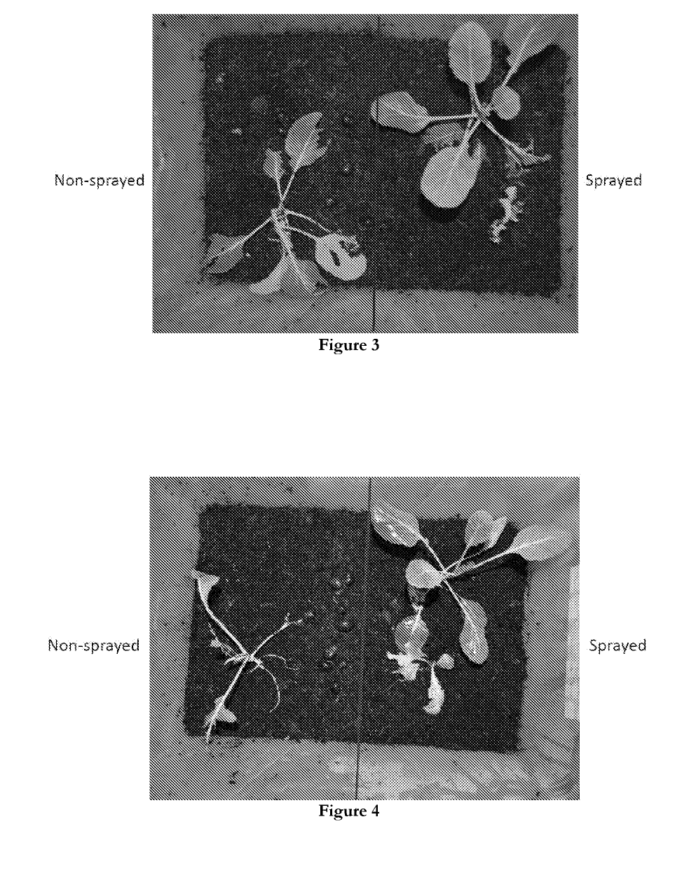

Day 5—The lettuce and bean at the non-sprayed end of the container were both eaten, with the lettuce all gone (FIG. 4, left hand side of container).

3. Container 3—2× Label Rate

Day 1—All snails avoided the sprayed half (right) of container and ate some cabbage and lettuce on the non-treatment side.

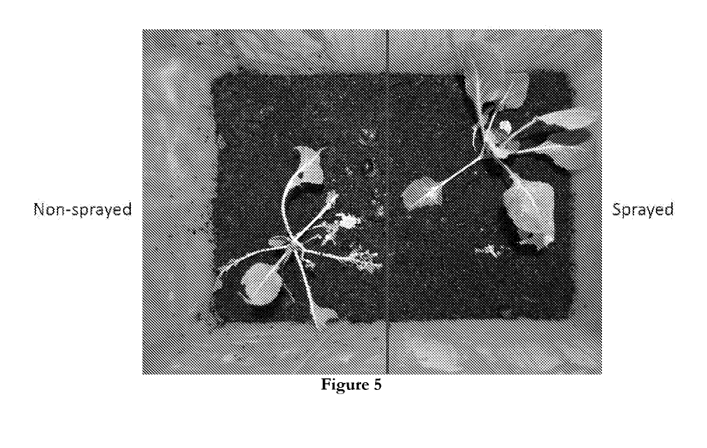

Day 5—Some damage to the bean and the lettuce was observed in the treatment half of the container, but less than that observed in the non-treatment side. Two live snails were found on the compost in the treated half of the container (FIG. 5, right hand side).

### Discussion

The data above indicates that the compositions of the invention were repellent to Brown Garden Snails at the label rate, and at a more concentrated application rate. Eventually, with no further application the snails may re-enter the treated area and eat treated lettuce and cabbage. The molluscicidal effect of the compositions of the invention is not immediate at these application rates, with snails which entered the treated area and ate treated plants surviving for one day plus. Notably, damage to treated plants was substantially less than that to non-treated plants.

### INDUSTRIAL APPLICATION

As will be evident from the above description, the present invention provides molluscicidal compositions comprising saponins or saponin fractions from Camellia sinensis useful for the control of molluscs, including terrestrial molluscs, together with methods for the preparation and use of such compositions. The compositions and methods of the invention have utility in a wide range of agricultural and horticultural applications, and provide horticulturalists with a useful means of controlling plant pests.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

One of ordinary skill in the art will appreciate that starting materials, reagents, purification methods, materials, substrates, device elements, analytical methods, assay methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may he resorted to by those skilled in the art, and that such modifications and variations are considered to be within the scope of this invention as defined by the appended claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

All references cited herein are hereby incorporated by reference in their entirety to the extent that there is no inconsistency with the disclosure of this specification. Some references provided herein are incorporated by reference to provide details concerning sources of starting materials, additional starting materials, additional reagents, additional methods of synthesis, additional methods of analysis, additional biological materials, additional nucleic acids, chemically modified nucleic acids, additional cells, and additional uses of the invention. All headings used herein are for convenience only. All patents and publications mentioned in the specification are indicative of the levels of skill of those skilled in the art to which the invention pertains, and are herein incorporated by reference to the same extent as if each individual publication, patent or patent application was specifically and individually indicated to be incorporated by reference. References cited herein are incorporated by reference herein in their entirety to indicate the state of the art as of their publication or filing date and it is intended that this information can be employed herein, if needed, to exclude specific embodiments that are in the prior art.

1-25. (canceled)

26. A method for producing a composition comprising one or more saponins from Camellia sinensis, the method comprising:
providing Camellia sinensis or a tissue therefrom or an extract thereof, wherein the Camellia sinensis, the tissue, or the extract comprises one or more saponins,
admixing the Camellia sinensis or the tissue therefrom or the extract thereof and water,
maintaining the admixture for a first period at
a) greater than about 100° C., or
b) greater than about 1 atmosphere, or
c) both (a) and (b),
maintaining the admixture for a second period at
d) about room temperature, or
e) less than one atmosphere, or
f) both (d) and (e), and
removing the supernatant, and optionally combining the supernatant with one or more agriculturally-acceptable carriers, thereby to form the composition.

27. The method according to claim 26, wherein the admixture is maintained for a first period at greater than about 100° C. and greater than about 1 atmosphere.

28. The method according to claim 26, wherein the admixture is maintained for a second period at about room temperature and at less than one atmosphere.

29. The method according to claim 26, wherein the first period is at least about an hour.

30. The method of claim 26 wherein the second period is at least about 12 hours, more preferably at least about 24 hours.

31. The method according to claim 26 wherein the admixture is maintained for the first period at about 110° C. and at about 1.3 bar.

32. The method according to claim 26 wherein the admixture is maintained for the second period at about 0.3 bar.

33. A method of preparing a saponin or saponin fraction having molluscicidal activity, the method comprising:
providing Camellia sinensis or a tissue therefrom or an extract thereof, wherein the Camellia sinensis, the tissue, or the extract comprises one or more saponins,
admixing the Camellia sinensis or the tissue therefrom or the extract thereof and water,
maintaining the admixture for a first period at
a) greater than about 100° C., or
b) greater than about 1 atmosphere, or
c) both (a) and (b),
maintaining the admixture for a second period at
d) about room temperature, or
e) less than one atmosphere, or
f) both (d) and (e), and
removing the supernatant, optionally purifying the saponin or saponin fraction, thereby to recover the saponin or saponin fraction.

34. A composition comprising one or more molluscicidal saponins or one or more molluscicidal saponin fractions from Camellia sinensis and comprising at least one agriculturally acceptable carrier, wherein the composition is or comprises an aqueous extract from Camellia sinensis wherein the extract is or was prepared by extraction with aqueous solvent at
(a) greater than about 100° C., or
(b) greater than one atmosphere, or
(c) both (a) and (b).

35. The composition according to claim 34 wherein the composition is or comprises an aqueous extract having one or more identifying characteristics of one or more saponin fractions described herein in Example 1.

36. The composition according to claim 35 wherein the identifying characteristic is a mass spectrometry profile essentially as shown in FIG. 1A or FIG. 1B.

37. The composition according to claim 34 comprising at least about 5 g.L⁻¹ of one or more saponins or saponin fractions.

38. An isolated, purified or substantially pure molluscicidal saponin fraction from Camellia sinensis, wherein the fraction is or comprises an aqueous fraction from Camellia sinensis wherein the fraction is or was prepared by extraction with aqueous solvent at
(a) greater than about 100° C., or
(b) greater than one atmosphere, or
(c) both (a) and (b).

39. The saponin fraction according to claim 38 having one or more identifying characteristics of one or more saponin fractions described herein in Example 1.

40. The saponin fraction according to claim 39 wherein the identifying characteristic is a mass spectrometry profile essentially as shown in FIG. 1A or FIG. 1B.

41. The saponin fraction according to claim 38 wherein the fraction is or was prepared by extraction with aqueous solvent at
(a) greater than about 100° C., or
(b) greater than one atmosphere, or
(c) both (a) and (b), and
maintenance for a second period at
d) about room temperature, or
e) less than one atmosphere, or
f) both (d) and (e).

42. A method of controlling one or more molluscs, the method comprising contacting the one or more molluscs with a composition comprising one or more molluscicidal saponins or one or more molluscicidal saponin fractions from Camellia sinensis and at least one agriculturally acceptable carrier, wherein the composition is or comprises an aqueous extract from Camellia sinensis wherein the extract is or was prepared by extraction with aqueous solvent at
(a) greater than about 100° C., or
(b) greater than one atmosphere, or
(c) both (a) and (b).

43. The method according to claim 42 comprising applying the composition to a plant or its surroundings.

44. The method according to claim 42 wherein the application is prophylactic application.

45. The method according to claim 42 wherein the concentration of saponin is about 0.5 gm/L to about 10 gm/L at application.
